(19) United States
(12) Patent Application Publication
(10) Pub. No.: US 2009/0316688 A1
(43) Pub. Date: Dec. 24, 2009

(54) METHOD FOR CONTROLLING ADVANCED MULTIMEDIA FEATURES AND SUPPLEMTARY SERVICES IN SIP-BASED PHONES AND A SYSTEM EMPLOYING THEREOF

(76) Inventor: Venkat Srinivas Meenavalli, Andhra Pradesh (IN)

Correspondence Address: KANESAKA BERNER AND PARTNERS LLP, 1700 DIAGONAL RD, SUITE 310, ALEXANDRIA, VA, 22314-2848, US

(21) Appl. No.: 12/310,047

(22) PCT Filed: Jul. 13, 2006
(86) PCT No.: PCT/IN06/00247

§ 371 Date: Sep. 8, 2009

(51) Int. Cl. H04L 12/66; G06F 15/16

(52) U.S. Cl. 370/352; 709/228

(57) ABSTRACT

A method for controlling the advanced multimedia features and supplementary services, such as integration with Internet TV powered by online advertising including interactive video, banner, text ads, online tracking tool which tracks users behaviour, along with various features of communication and infotainment like Phone calls including PC to PC, PC to land line, PC to mobile and vice versa, Video Phone, Chat & TV (Internet Television), on-line shopping/store with facilities like searching of web, follow me facility, world clock and adding of favorites etc that are implemented within Internet Protocol (IP) based telephony technology using Session Initiation Protocol (SIP) for its communications. Moreover the present application provides an interactive solution by offering free talk time to the users based on the duration of watching of the internet television, using and interacting with the disclosed soft phone and also incorporating some viewer friendly solutions for entertainment, communication across the globe.

The present specification is in continuation to the PCT application number PCT/IN05/00151 dated 10.05.2005 entitled “System and an improved method for controlling multimedia features and services in SIP-Based Phones”, the entirely of which is incorporated herein by reference.

### FIELD OF INVENTION

The present application relates to system architecture and a method for controlling advanced multimedia features and supplementary services in SIP based phones. In particular, the present application relates to an architecture and method for controlling the advanced multimedia features and supplementary services, such as integration with Internet TV powered by online advertising including interactive video ads, banner ads, text ads, online tracking tool which tracks users behaviour, along with various features of communication and infotainment like Phone calls including PC to PC, PC to land line, PC to mobile and vice versa, Video Phone, Chat, and TV (Internet Television), On-line shopping/store with facilities like searching of web, follow me facility, world clock and adding of favorites etc that are implemented within Internet Protocol (IP)-based telephony technology using Session Initiation Protocol (SIP) for its communications. Moreover the present application provides an interactive solution by offering free talk time to the users based on the duration of watching of the internet television, using and interacting with the disclosed soft phone and also incorporating some viewer friendly solutions for entertainment, communication across the globe with the new disclosed revolutionary redefined method of communications.

### BACKGROUND OF THE INVENTION

Technological advancements and customer demands have compelled telephone companies and Internet service providers to provide communication “solutions” rather than just a dial tone. The changes in the telecommunications field over the years have encouraged the inventors and others service providers to push carriers far beyond their original core business of providing basic connectivity.

But carriers are faced with a problem. Today's legacy public switched telephone network (PSTN), while reliable and robust, is built on hardware-based circuit switches that leave little room for innovation and service differentiation. Many carriers are solving this problem by migrating networks to IP-based technology, but they may still have huge investments in the PSTN hardware that are not fully depreciated. This means that as network migration continues, a hybrid PSTN/IP environment will emerge, with traffic being directed across both the PSTN and IP systems.

When IP-based telephony technology, such as SIP, emerges, many end devices may be able to provide the multimedia features and supplementary services without permission from the network-centric devices of the service providers. As a result, the capability of controlling the feature/service delivery from these network-centric devices may also be deteriorated. Under this scenario, service providers will likely be able to only enable uniform multimedia features and supplementary services for all of its customer's end devices or rely on static provisioning for each such end device to enable/disable certain unwanted features/services.

Accordingly, service providers want a mechanism of better controlling the multimedia features and supplementary services delivery from the network core, even though these multimedia features and supplementary services are actually provided by the end devices that reside in the end user premises. The present invention defines an architecture and mechanism for network core devices (e.g., SIP servers) to control end devices (e.g., SIP phones) to deliver the multimedia features and supplementary services dynamically and based on per user account profiles. With the architecture and mechanism of the present invention, service providers can selectively provide these services to proper groups of users by indicating such feature/service information in the communication packets (e.g., SIP messages). The end devices used with the present invention will also provide multimedia features and supplementary services only as directed in such communication packets. Consequently, service providers will regain network-concentric control over the multimedia features and supplementary services that they provide in an IP or hybrid PSTN/IP telephony system.

### SUMMARY OF THE INVENTION

The present invention provides a system and method for communicating data using Session Initiation Protocol (SIP) as a communication protocol constructing a New Generation Network (NGN), in order to ensure stable and reliable data transmission.

According to an aspect of the present invention, there is provided a method for communicating data between a client and a server, the method comprising: (a) initializing a communication session using Session Initiation Protocol (SIP); (b) requesting the server for data using a Reliable Data Transfer (RDT) message as an expanded SIP, receiving data, and checking whether the data is correctly received; and (c) terminating the communication session using SIP.

According to another aspect of the present invention, there is provided a computer readable medium comprising: a Session Initiation Protocol (SIP) message, which includes an SIP header part required for initializing a session and an SIP body part capable of performing a desired function through a set session; and an RDT message, which includes a command representing a type of a command to be executed and at least one parameter with information required for executing the command, and is included in the SIP body part.

In another aspect of the present invention, there is provided a system for communicating data between a client and a server, the system comprising: a user agent client (UAC), which requests desired data using a Reliable Data Transfer (RDT) message as an expanded Session Initiation Protocol (SIP) and checks whether the data is correctly received; and a user agent server (UAS), which combines the requested data with information indicating whether the data is correctly transmitted, using the RDT message as the expanded SIP, and transmits the resultant data.

The user agent client (UAC) which requests a server for data comprises: a Reliable Data Transfer (RDT) message processor which converts information on requested data into an RDT message and extracts the requested data from a received RDT message; a Session Initiation Protocol (SIP) stack which communicates an SIP message including an RDT message from/to the server; a data application unit which processes or stores the extracted data; and a data controller, which sends information on requested data to the RDT message processor and transfers a transformed RDT message to the SIP stack, and sends an RDT message received from the SIP stack to the RDT message processor and transfers information on the extracted data to the data application unit.

The user agent server (UAS) which provides data to a client, the server comprising: a Reliable Data Transfer (RDT) message processor which extracts information on requested data from a received RDT message, and transforms the information on requested data into an RDT message; a Session Initiation Protocol (SIP) stack which communicates an SIP message including an RDT message from/to the client; a data provider which provides data corresponding to the information on requested data to a data controller; and a data controller, which sends an RDT message received from the SIP stack to the RDT message processor and transfers information for the extracted data to the RDT message processor, and sends information on data received from the data provider to the data provider and transfers a transformed RDT message to the SIP stack.

According to another aspect of the present invention, there is provided a computer readable medium having embodied thereon a computer program for the data communication method.

The present application provides a method for controlling features and services comprising the step of identifying a profile, specifying which features and services may or may not be implemented by an end device, from user account information stored on a network core device. Moreover, the present application provides another method for controlling features and services in packet-based networks that comprises the steps of sending a first message to a network core device, and identifying a profile, specifying which features and services may or may not be implemented by an end device, from user account information stored on the network core device. The method further comprises the steps of adding the profile to a second message, and sending the second message from the network core device to the end device.

The present application provides a voice over internet protocol (VOIP) having a session initiation protocol (SIP) with SIP User Agent [RFC-3261] has multi-featured phone designed for enterprises and residential use. It has unique features that are not available in other SIP phones. It is based on the widely deployed SIP protocol design to meet the requirements of service providers and system integrators. Some of the other features which make the present invention distinguishable from the prior art are:—

As per one of the embodiment of the present invention there is provided a video phone which is a free downloadable soft phone integrated with voice, video, IM, and real time video streaming, powered by online advertising.

Another exemplary embodiment of the present invention provides a method wherein the SIP Video Phone converts a laptop or desktop into a second telephone. One can make calls to any phone around the world. One can also receive unlimited free incoming calls from any landline or mobile phone across the world with the disclosed SIP Video Phone and moreover the PC to PC calling is absolutely free.

As per another embodiment of the present invention there is provided a soft video phone wherein one can make PC to PC real time video calls, also can talk to their buddies and family members in live video action with the help of some mere attachments like a webcam and a microphone and headset.

As per another embodiment of the present invention there is provided a soft phone wherein the voice call method further comprises the features of Call forwarding, Call blocking or Ignoring calls, Call return, Call trace, Last Call Duration, Recent Number List, Caller ID, Compatibility with Windows 2000/XP operating systems, Proxy Authorization support, Address Book, Volume Visualization, Easy User Installation, Click to call, Music player, Business Processing, Realtime online adding of funds, Caller ID blocking, Priority ringing and Conference calling etc.

As per another embodiment of the present invention there is provided a soft video phone wherein one can also enjoy chatting with the buddies and for that the buddies are added to a contact list and then chatting can be started.

As per another embodiment of the present invention there is provided a World clock which helps the user to view the world wide time. This utility is very useful to check the destination time while making a call (or) while chatting.

As per another embodiment of the present invention there is provided a soft Video Phone presents an incessant entertainment with free online video streaming.

As per another embodiment of the present invention there is provided a soft Video Phone wherein the facility of Automatic Network Detection enables the user to know the changes in his network. If the network is down the disclosed video phone will sign out and when the net resumes the same will automatically sign in and resumes.

As per yet another embodiment of the present invention there is provided a soft Video Phone wherein a Phone Book enables the user to add the some of the information like name, e-mail, Office phone, Mobile and home phone etc which helps/assists the user in making a call via disclosed phone to others number.

As per yet another embodiment of the present invention there is provided a soft Video Phone wherein View name files enables the user to share other buddy files.

As per yet another embodiment of the present invention there is provided a soft Video Phone wherein the incorporated “My Favorites” module contains videos of the area of interest of the user.

As per yet another embodiment of the present invention there is provided a soft Video Phone wherein the incorporated “My News” is a scrolling news module where the user can watch the news and also customize the news according to his interest

As per yet another embodiment of the present invention there is provided a soft Video Phone wherein an incorporated “My Files” module makes the user to upload audio files, image files and video files of his area of interest, those files can be viewed by other buddies. The user can upload files up to 10 GB.

As per another embodiment of the present invention there is provided a soft Video Phone wherein Auto login and Auto Startup facility is incorporated for regular users which facilitates the regular users to login without typing the user name and password every time in his system.

Another exemplary embodiment of the present invention provides a method wherein call barring, call transferring, call hold, and other facilities are included in the disclosed soft video phone.

Another exemplary embodiment of the present invention provides a soft Video Phone wherein the user is facilitated by providing free telephoning worldwide based on the duration of viewing the internet television.

Another embodiment of the present invention is to provide a ‘Follow Me Service’ facility, where one can get their calls redirected to their landline or mobile phone when they are offline.

As per one of the exemplary embodiment of the present invention there is provided a module named as “My files module” which is used to upload audio, video and image content for any user. The user can upload up to 10 GB of content.

Another exemplary embodiment of the present invention is to provide a facility where the user can search the Web powered by LYCOS even while making calls or chatting with his/their buddies.

Another exemplary embodiment of the present invention provides a soft video phone integrated with Internet TV with its own channel called Globe-7 TV along with other numerous TV channels. The soft video phone TV lets to watch world news, world business news, world entertainment news, Hollywood movie trailers and more.

Another exemplary embodiment of the present invention provides a soft video phone integrated with online advertisements including interactive video advertisements, banner advertisements and text advertisements and online trading facilities to help the user to buy, sell or advertise their products to millions of users.

Another exemplary embodiment of the present invention is to provide an intelligent soft phone wherein the advertisements, trading, searching of web are interconnected and are tracked by geographic and demographic based locations on user's interests so that the user can be helped with the links.

Another exemplary embodiment of the present invention is to provide a tool for online tracking which tracks the user's behaviour.

Another exemplary embodiment of the present invention provides a soft video phone wherein the IM environment possesses number of emotion icons which are unique and interesting to express the feelings non-verbally and symbolically.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE ACCOMPANYING DRAWINGS

The above and other features and advantages of the present invention will become more apparent by describing in detail exemplary embodiments thereof with reference to the attached drawings in which:

FIG. 1 shows the video phone architecture as per the present invention.

FIG. 2 is a Globe7 Video Phone (version 3.0) Registration and Call-Signaling Code Flow diagram.

FIG. 3 is a Real time Protocol (RTP) Communication Code Flow diagram.

FIG. 4 (a) shows Globe7 Video Phone (version 3.0) SIP to PSTN call Flow as per the present invention.

FIG. 4 (b) shows SIP-SIP Call flow diagram as per the present invention.

FIG. 5 shows the GUI (Graphical User Interface) of the Globe7 Video Telephone (version 3.0) as per the present invention.

FIGS. 6 (a) and 6 (b) shows the GUI (Graphical User Interface) of the authentication/Registration method as per the present invention.

FIG. 7 (a) to 7(e) shows the GUI's (Graphical User Interface) of the dial pattern as per the present invention.

FIG. 8 (a) to 8 (d) shows the GUI's (Graphical User Interface) of the dial pattern and disconnection of call as per the present invention.

FIG. 9 shows the GUI (Graphical User Interface) of the volume control of Globe7 Video Phone Version 3.0.

FIG. 10 (a) to 10 (f) shows the GUI's (Graphical User Interface) for the call history and its properties along with accessibility and deletion as per the present invention.

FIG. 11 (a) to 11 (b) shows the GUI's (Graphical User Interface) of the TV/Video module and its different operations as per the present invention.

FIG. 12 (a) to 12 (e) shows the GUI (Graphical User Interface) of the phone book as per one of the embodiment of the present invention.

FIG. 13 (a) to 13 (j) shows the GUI's (Graphical User Interface) of the video calling facility, enabling of webcam as per one of the embodiment of the present invention.

FIG. 14 (a) to 14 (d) shows the GUI's (Graphical User Interface) of the video call receiving facility as per one of the embodiment of the present invention.

FIG. 15 (a) to 15 (d) shows the GUI's (Graphical User Interface) of the chatting facility and adding of the new contacts as per the embodiment of the present invention.

FIG. 16 (a) to 16 (d) shows the GUI's (Graphical User Interface) for the status of the added contacts as per the embodiment of the present invention.

FIG. 17 (a) to 17 (h) shows the GUI's (Graphical User Interface) for sending an instant message during a chat session as per the present invention.

FIG. 18 (a) to 18 (c) shows the GUI's (Graphical User Interface) for the “My news” module as per one of the embodiment of the present invention.

FIG. 19 shows the GUI's (Graphical User Interface) for “My favourite” module as per the embodiment of the present invention.

FIG. 20 (a) to 20 (b) shows the GUI's (Graphical User Interface), which provides free real time video, streaming (RTMP) as per the embodiment of the present invention.

FIG. 21 shows the GUI (Graphical User Interface) for “My files” module as per one of the embodiment of the present invention.

FIG. 22 (a) to 22 (b) shows the GUI's (Graphical User Interface) for a web searching facility included in the Globe7 Video Phone as per one of the embodiment of the present invention.

FIG. 23 shows the GUI's (Graphical User Interface) for the “store” module included in the Globe7 Video Phone as per one of the embodiment of the present invention.

FIG. 24 is a comparison chart with other available SIP based phones

### DETAILED DESCRIPTION OF EXEMPLARY EMBODIMENTS

SIP, the Session Initiation Protocol, is a signaling protocol for Internet conferencing, telephony, presence, events notification and instant messaging. SIP was developed within the IETF MMUSIC (Multiparty Multimedia Session Control) working group. SIP is a text-based protocol, similar to HTTP and SMTP, for initiating interactive communication sessions between users. Such sessions include voice, video, chat, interactive games, and virtual reality.

SIP, Session Initiation Protocol, is a signaling protocol over IP mainly deployed for Internet conferencing, telephony, presence, events notification and instant messaging
Request/response protocol (like HTTP but peer-peer)
Simple and extensible.
Designed for mobility.(proxy redirect servers)
Bi-directional authentication
Capability negotiation.

SIP is used for controlling the signaling that enables manipulation of sessions such as:
1. Instant messaging sessions
2. Phone calls over the Internet
3. Gaming Servers.
4. Resource Location

Architecture

This present invention is using Session IP by osip library and for real time communications Ortp library te coding is done using C/VC++. Further there is a UAC (User Agent Client) and UAS (User Agent Server) running in the code. The UAC of the caller communicates with the UAS of the callee. This is done with a proxy in the middle. The proxy server contacts one or more clients or next hops to servers and passes the call requests further servers having UAC and UAS.

Hereinafter, embodiments of the present invention will be described in detail with reference to the appended drawings.

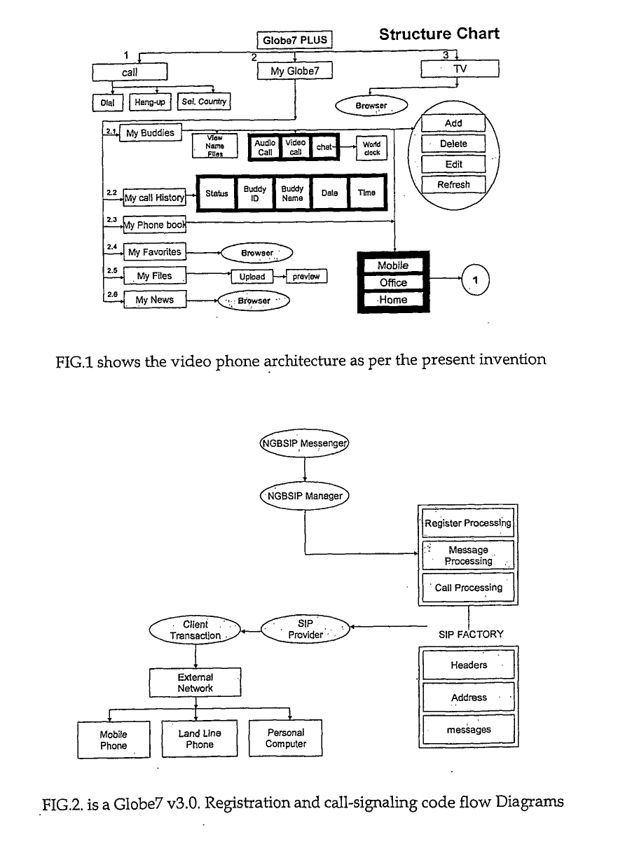

FIG. 1 shows the Video Phone architecture as per the present invention. The Video Phone Launch Version Osip stack. The disclosed Globe7 has been developed by implementing C/VC++ programming. The SIP stack that has been used is OSIP RTP handling is based on ORTP. FIG. 2 is a Globe7 Video Phone Registration and Call-Signaling Code Flow diagram. This is the basic flow in which our video phone gets registered and after which the call generates. Here using the SIP stack the call parameters are generated and the call signal is sent to the target callee or a call is received and is processed.

The coding and the flow has been done in C/VC++ for reducing the memory size to only 5 MB. The JAVA standard interface requires a memory size of 20 MB which makes the system slow and a bit costlier. The migration is significant in respect of the speed and the cost of the memory size.

OSIP is a C SIP signaling stack. It wraps all low-level stack and protocol abstractions in a C interface layer, and allows an application to embed a OSIP stack and access low level functions with the help of Globe7 API.

As discussed the ORTP is utilized to handle RTP media, because ORTP provides plenty of functionalities to manipulate time based media and real time communications. Furthermore media handlers are required to manipulate the raw RTP data directly. Globe7 API uses ORTP library which integrates GSM, ILBC Audio codec's and H263 video codec.

The present invention is now onwards termed as Globe7 is a SIP User Agent [RFC-3261] has multi-featured yet cost competitive phone designed for enterprises and residential use. It has unique features that are not available in other SIP phones. It has been fully tested for interoperability. It is based on the widely deployed SIP protocol design to meet the requirements of service providers and system integrators. Using Our Globe7 one can call any mobile or land line in any corner of the world and similarly one can receive calls from the same. There is a browser embedded in the present invention which plays some strips containing advertisements are displayed. There is a feature of Video Advertisement on TV module.

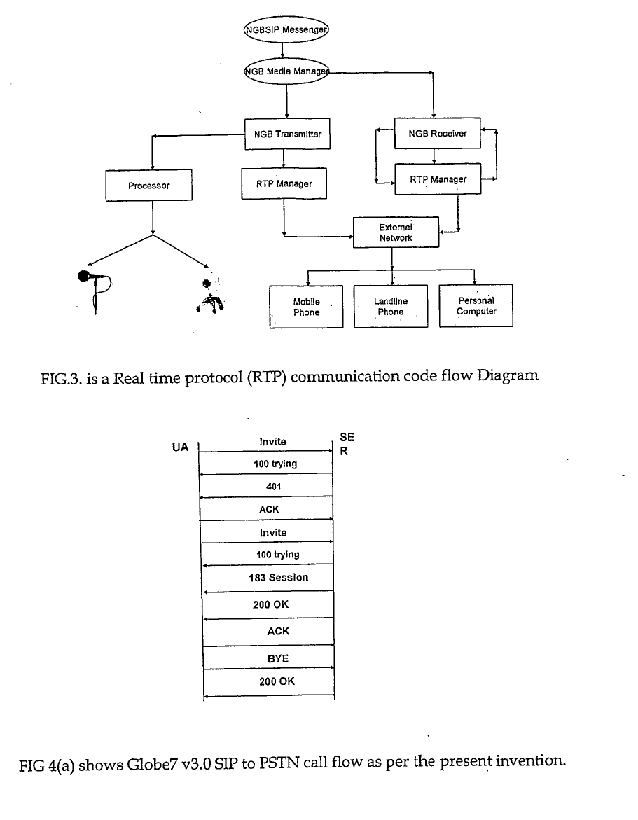

FIG. 3 is a Real time Protocol (RTP) Communication Code Flow diagram. Here once the call is established, the Real Time Protocol comes in to picture. The figure explains how the communication takes place using Ortp library and Globe 7 API for voice packets with the help of the codecs are generated and then sent or received.

The minimum system requirements for the operation of the soft phone as disclosed is as under.

| S | | | Recommended/ |
|---|---|---|---|
| No | Component | Minimum required | Preferred |
| 1. | Processor | 500 MHz Processor | 1 GHz or more |
| 2. | Operating | Windows 2000 and | Windows XP with |
| | System | greater | service pack 2 |
| 3. | RAM | 64 MB RAM | 128 MB RAM |
| 4. | Hard disk | 100 MB of | 250 MB of |
| | | free space | free space |
| 5. | Sound | Audio Drivers should be installed/Updated | |
| | | Sound devices should be in proper working condition | |
| 6. | Web cam | — | Any standard Model |
| 7. | Flash media | FLV Playback | — |
| | Player | Component. | |
| 8. | Internet | 128 kbps | 256 kbps |
| | connection | | |
| | speed | | |
| 9. | Browser | IE 6.0 or similar | IE 7.0 |

| | | |
|---|---|---|
| 10. | Connectivity | Dial UP/Broadband/DSL/ADSL/Cable |
| 11. | Codecs | iLbc, gsm, H263 |

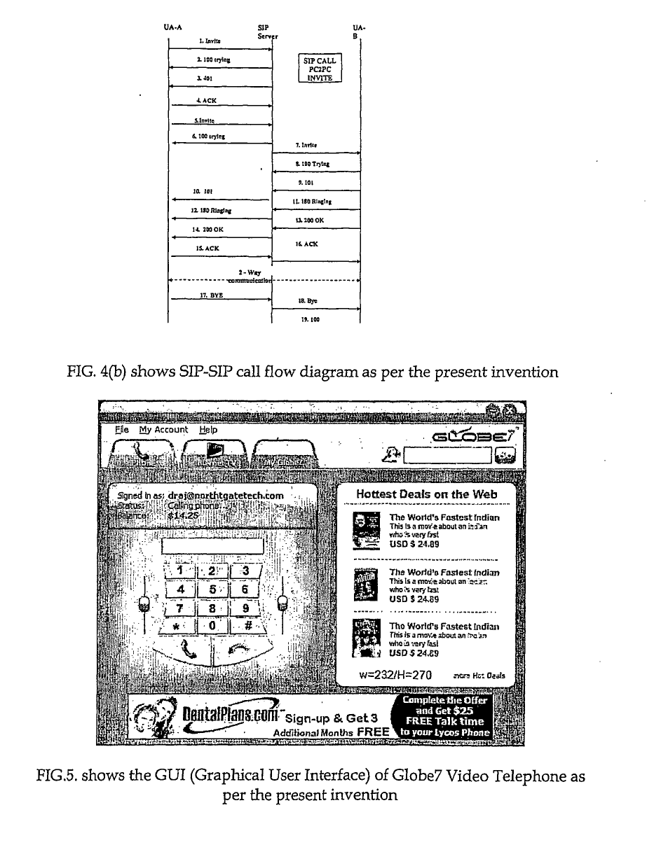

FIG. 4 (a) shows Globe7 Video Phone Version 3.0 SIP to PSTN call flow and FIG. 4 (b) shows SIP-SIP Call flow diagram as per the present invention. These figures describe the basic flow in which the phone gets registered and after which the call generates. Here using the sip stack the call parameters are generated and the call signal is sent to the target callee or a call is received and is processed.

The different steps involved in the process of the communication is as under:—

Step1: First, Globe7 Video Phone user agent A sends out an INVITE request to initiate a call. User Globe7 Video Phone User agent B then replies with the Trying response code (100), indicating that the call request is being processed.

Step 2: Globe7 Video Phone user agent B then replies with the OK response code (200), indicating that that user agent has accepted the call.

Step 3: User agent A then replies to Globe7 Video Phone user agent B with an acknowledgement (ACK) request, indicating that user agent A received the final response code from Globe7 Video Phone user agent B.

Step 4: The real-time data is then encapsulated in RTP packets and sent between Globe7 Video Phone user agent A and Globe7 Video Phone user agent B. Either Globe7 Video Phone user agent A or Globe7 Video Phone user agent B can then send a BYE request, indicating that the user agent wants to terminate the session. Globe7 Video Phone user agent B then sends an OK response code (200) to Globe7 Video Phone user agent to indicate that the request has succeeded. Here RTP Media Communication establishes on both sides.

FIG. 5 shows the GUI (Graphical User Interface) of the Globe7 Video Telephone as per the present invention. The different innovative features/functions defined above are included in the interface. The Globe7 icon is to be clicked to start Globe7 application.

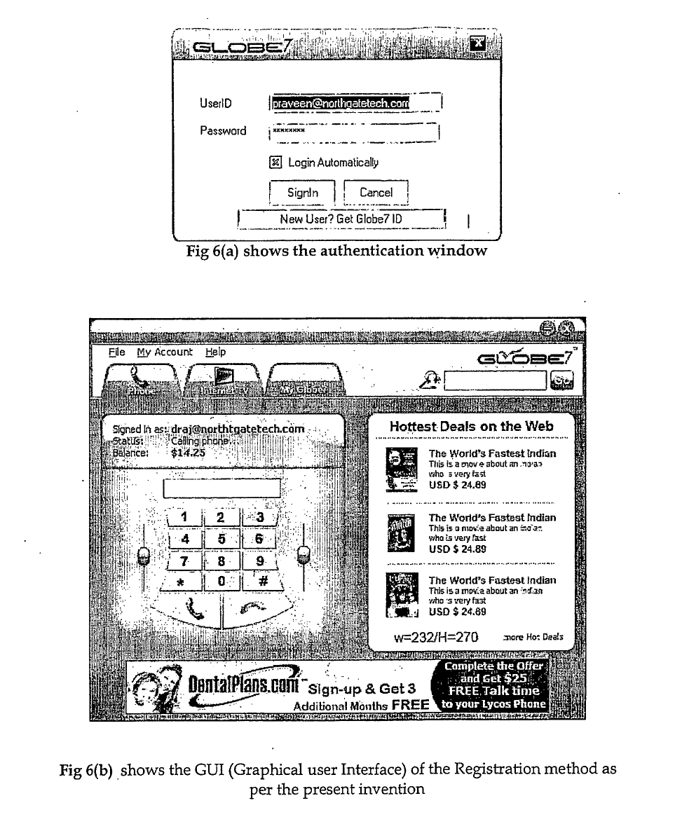

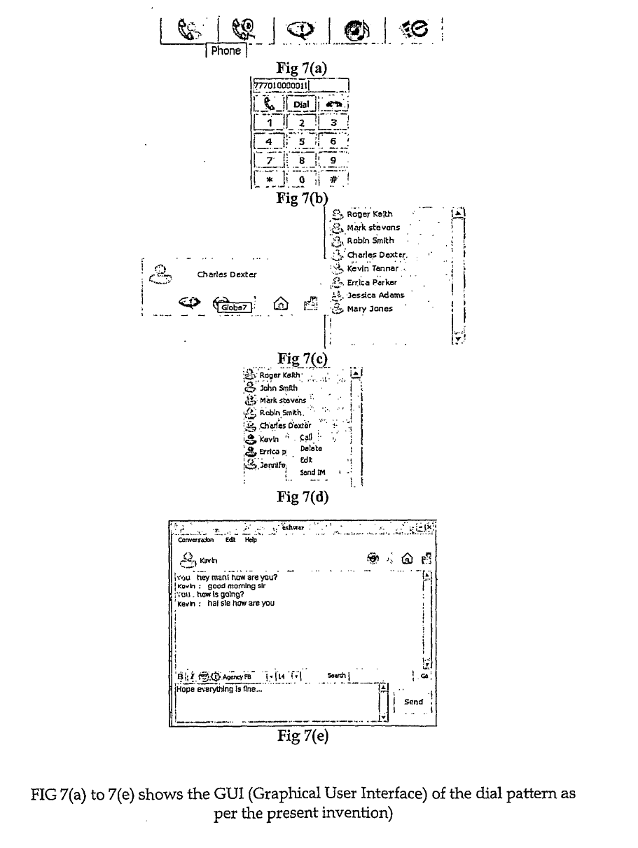

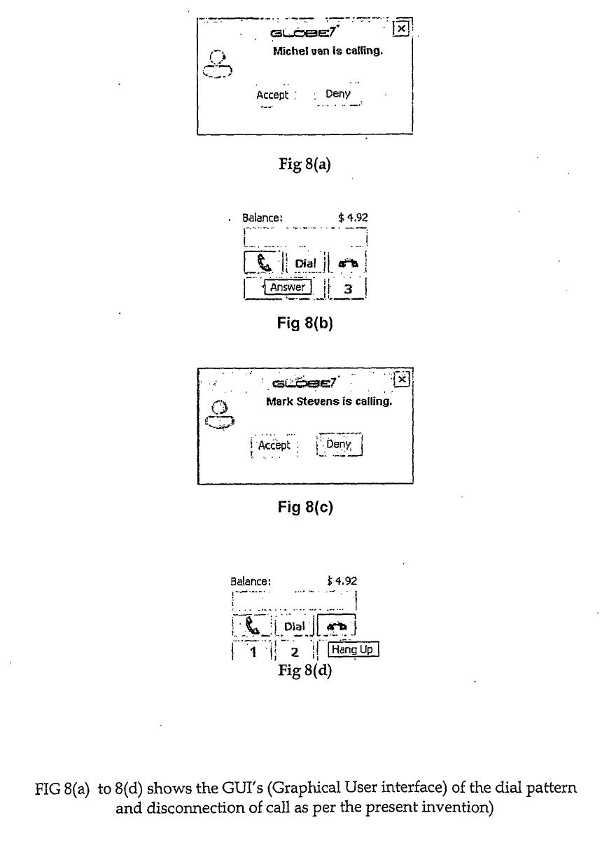

FIG. 6(a) shows the GUI (Graphical User Interface) of the authentication (Registration method). Globe7 application opens along with an authentication window. For login, the user has to enter the unique Globe7 ID and Login Password. Enabling the check box ‘Remember my ID & Password’, one need not enter his ID and password every time he login. Ensure that his Internet connection is active. FIG. 6(b) shows the GUI wherein the users sign in status is displayed along with his account balance. If the visitor is a new user, he has to click the button, ‘New User? Get Globe7 ID’. He will be directed to the Globe7 registration Page.

FIG. 7 (a) shows the Dial Pattern, How to Make a Call? Whenever a user logs in to Globe7, the default Phone screen appears. If the user is in the other screen, ha has to click the ‘Phone’ tab to see the Phone screen. Ensure that he has clicked the ‘Dial’ tab on the phone screen.

One can make a voice call through Globe7 in six different ways. FIG. 7(b) shows the GUI for making a call. The phone number is entered in the text field by clicking on the displayed numbers or typing from the key board. Afterwards clicking the ‘Dial’ button connects the call.

For International Calls, the dial order is: 00+Country Code+Regional Code+Telephone Number. e.g. 00+91+40+23544625. For US and Canada, dial in this order I+Regional Code+Telephone Number e.g. 1+781+6132085

FIG. 7(c) shows another method for making a call. One can also make a call from the Buddy List by selecting a contact that he likes to call. A profile window will open displaying phone icons. The specified icon should be chosen and make a call to his buddy's Globe7, mobile, home or office number. Some other methods of making calls are shown in FIGS. 7(d) and 7(e).

By selecting a contact the user likes to call. Right click the contact and click ‘Call’ to connect to your buddy.

By double-clicking the contact to make a call to the users buddy. Just select the contact and press ‘Enter’.

One can even make a call through the chat window even while he/user is chatting. Choose the specified icon is chosen and a call is made to his buddy's Globe7, mobile, home or office number.

FIG. 8(a) shows the GUI for answering a Call. When one receives a call to his Globe7, he will hear a ringing sound. A call alerting box pops up allowing either accepting or denying the call. Click ‘Accept’ to answer the call. Similarly FIG. 8 (b) shows that the user can also answer the call by clicking the ‘Answer’ button.

FIG. 8(c) shows the method for disconnecting a Call. Then user receives a call to Globe7, a call alerting box pops up allowing him either to accept or deny the call. Click ‘Deny’ to disconnect the call.

FIG. 8 (d) shows another method for disconnecting a Call. One can also disconnect the call by clicking the ‘Hang Up’ button.

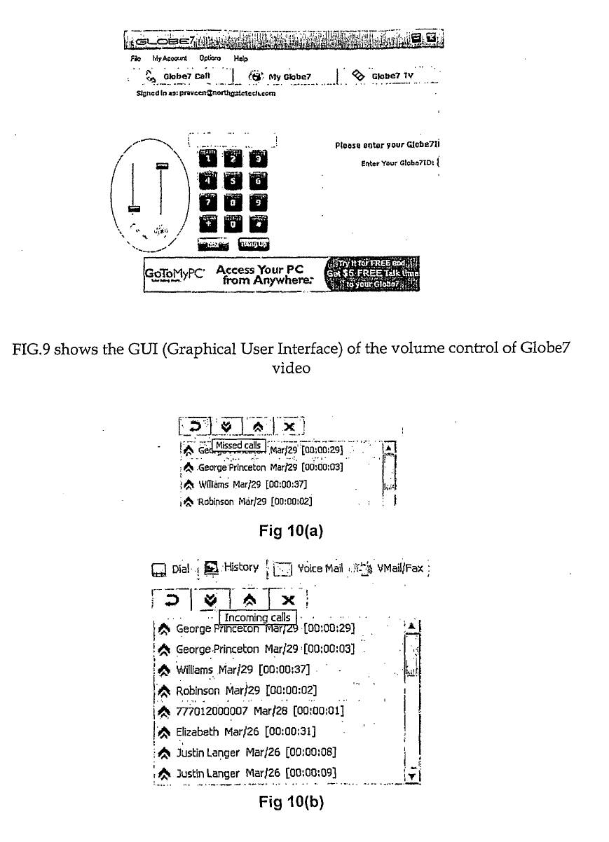

FIG. 9 provides GUI for Volume Control. While making or answering calls, one can control the volume by using the Volume Controller. To increase or decrease the volume, user need to move the Volume Controller knob up and down. Even when users are on a video call, he can use the volume controller to change the volume.

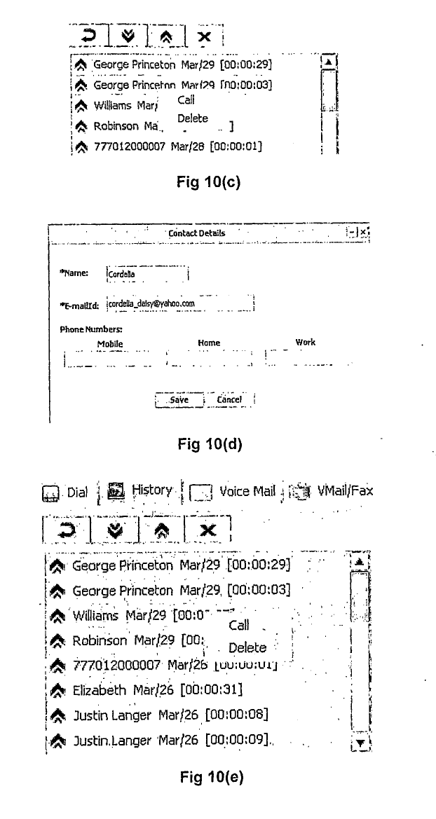

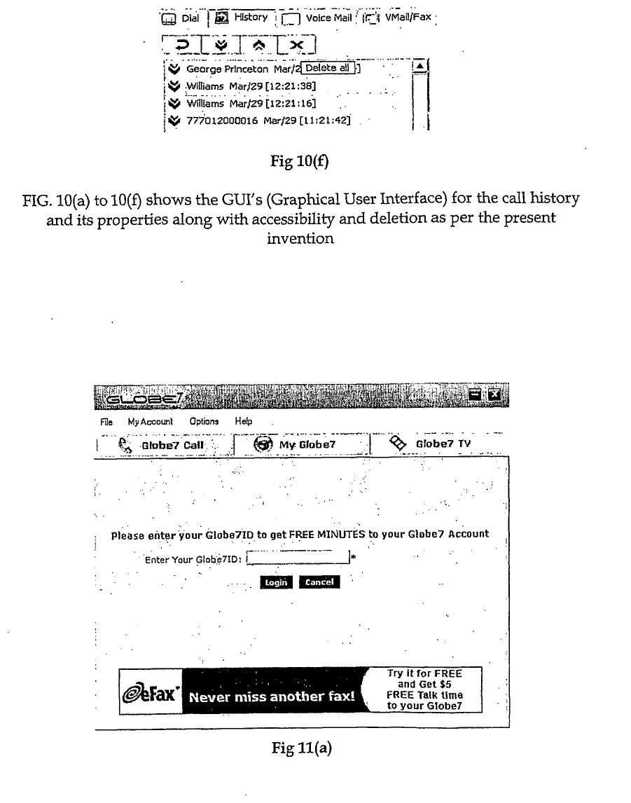

FIG. 10 (a) shows the GUI for the Call History. One can check all the call details—missed calls, incoming calls and out calls—on the phone screen. To check the call history, Click the ‘History’ tab. Select a button and the tool tip will guide the user.

FIG. 10 (b) shows a GUI which guides for clicking of the specified button and check ones call details with date and time. Apart from checking call details, one can make calls as well as add phone numbers to the Buddy List directly from there. Similarly, FIG. 10 (c) guides to make a call from the Out Calls list by selecting the number and right click the number and click ‘Call’.

FIG. 10 (d) shows a GUI; wherein a window with contact details is opened wherein one need to fill out the contact details. Clicking ‘Save’ stores the contact details.

FIG. 10 (e) shows the GUI for deleting a Call History. To delete a number from the call history, the number should be selected and thereby Right click the number and click ‘Delete’. Similarly, FIG. 10 (f) shows how to delete all the numbers from the call history at a time. It can be done by clicking the ‘Delete all’ button.

As per one of the exemplary embodiment of the soft video phone, a secured server is incorporated in the central location wherein the processor is programmed such that it records all the user ID's with their information's, locations etc and tracks all the features used by them. The secured server also records every minute of TV viewing by a particular user and stores in database at the server located in the central location. The time/duration spent by viewing TV by the user/viewer is converted into a call account and the viewer can use the account for calling globally using the disclosed soft video phone.

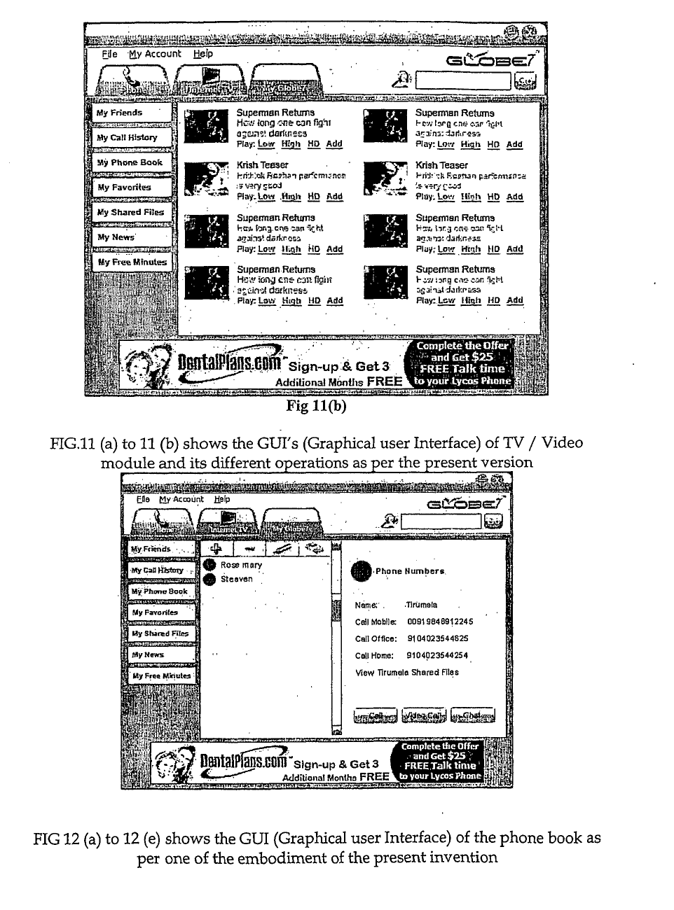

FIGS. 11 (a) and (b) shows the GUI (Graphical User Interface) of the TV/Video module and its different operations. As per the module the user is allowed to enter the E-mail/VDID and the corresponding password in the LOGIN WINDOW. Once the user enters the correct ID and password, the information is sent as http Request to the database (My SQL) for verification.
1. If the match is found then the user receives “SUCCESS” in the browser component.
2. If this does not match then the user receives “LOGIN FAILED” and will again get the login window to enter the correct user ID and password.
3. The user can however press the CANCEL button and view the video—but he will not be allowed to get credits to his account.
4. For Video's FLV Player can be used.
5. Observation will be also made on which TV Module which is accessed by more number of users and this information will be stored in the database (SQL Server) and correspondingly a COUNTER will get updated for that module.

The Flash Video Player Module.
1. Once the user enters the correct e-mail/password (or) cancels the login window option, then the web browser opens showing the FLV Player and TV Modules (so that the user can enter into any other TV module without going back to the previous menu.
2. He can watch the video by pressing the PLAY button.
3. The user can stop the video by pressing the STOP button
4. Duration is calculated which is the difference between the STOP event and PLAY event.
5. If the User switches to another TV Module then duration is calculated as follows.
   Total_Duration=New_Duration+Old_Duration.

As per the aforesaid embodiment of the present invention, in case the user closes the FLV Player Module then E-mail, total_duration will be sent to the MySQL Database and the database automatically updates the field Amout_added for the corresponding e-mail and duration. Also the amount gets be added to the Amount database of the Globe7 customer.

The Phone book module is basically used to add and store the phone and e-mail information of the buddies to Address Book Database of Globe7. The address book contains fields like Name, e-Mail, Mobile Phone, Office Phone and Home Phone.

The user can ADD, DELETE, EDIT and REFRESH the contents of the Phone Book.

In case the user presses the ADD Button the window as shown in FIG. 12(a) gets opened where the user need to fill the information like Name, e-mail, Mobile Phone, Office Phone and Home phone fields.

The fields Name and one of the Phone numbers is mandatory and remaining fields are optional. Name field cannot be empty/NULL.

There also validations for each and every field, like the name field should not cross 50 characters of length. E-mail should not cross 100 characters. All the phone numbers should not cross 25 characters of length.

On pressing the OK button the Buddy will be added to the Phone Book. On pressing CANCEL button the Add window will get closed.

Before deleting any buddy from the address Book, the user needs to select the buddy. Once the buddy is selected and the user presses the delete button, the buddy will be deleted from the address book. But before deleting a buddy from the address book, Globe 7 displays a confirmation message “Are you sure you want to delete?” If the user presses YES Button then the buddy will be deleted and a message will be displayed confirming that the “Buddy is deleted successfully” as shown in FIG. 12(b).

As shown in FIG. 12(c), in order to edit the information of any buddy in the address book, the user need to select the buddy. Once the buddy is selected the user can use the button “EDIT” to edit the information of the Buddy.

After changing the information, the user can use OK button to save the information which he has edited/updated.

Refresh button refreshes the buddies present in the Address Book. (FIG. 12(d))

The user can also make call to the buddy straight from the address book by pressing the call icon present towards the right side of the Phone number of the buddy which he has selected. The call will only be established successfully, if the user has the sufficient balance in his Globe7 account and the number is valid

When the user enters a Name having >50 characters Address book application should not accept it.

When the user enters an e-mail having >100 characters then application should not accept.

When one of the phone numbers (office, Home, Mobile) is blank then the address book application should ask the user to enter any one of the numbers.

When the user leaves the name field empty then he has to get a message that “Name field cannot be empty”

Under the Phone book module the user is able to ACCESS, STORE and MANIPULATE (EDIT, DELETE & REFRESH) the contents of the address book database.

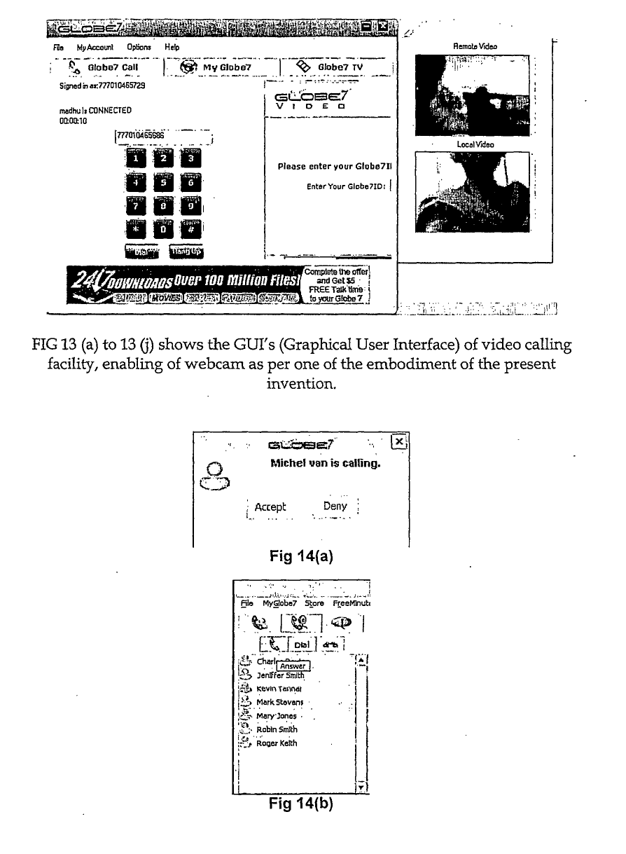

For making a video call, Apart from the regular voice calls, user can also make video calls through Globe7. To utilize the video calling facility, user need to enable his webcam (FIG. 13(a)). To enter the Video Phone screen, click the ‘Video Phone’ tab, provided that the user (FIG. 13 (b)) enables video before he gets connected to a video call. Similar to the voice mails the users can enable video in two ways:—
a). By clicking the ‘Enable Video’ button on the Video Phone screen.
b). By going to the ‘Options’ menu and click ‘Enable Video’ option. (FIG. 13 (c))

On enabling the video button, a message is displayed as ‘Please wait. Video is configuring’. Video configures in a few seconds. FIG. 13 (d) and FIG. 13 (e) shows that once the opponent enables his video, the video call can be started.

The GUI shown in FIG. 13 (f) shows the various six methods for making a video call:—
a). By selecting a contact in the Buddy List and then by clicking the ‘Dial’ button.
b). By selecting a contact and then by Right-clicking the contact and click ‘Call’. FIG. 13 (g).
c). By selecting a contact. A profile window opens with the display of phone icons, then clicking the Globe7 icon starts a video call. FIG. 3(h).
d). By Double-clicking the contact makes a video call to your buddy.
e). By selecting the contact and then by pressing ‘Enter’ button FIG. 13 (j)
f). One can even make a video call through the chat window even while chatting by clicking the Globe7 icon to make a video call.

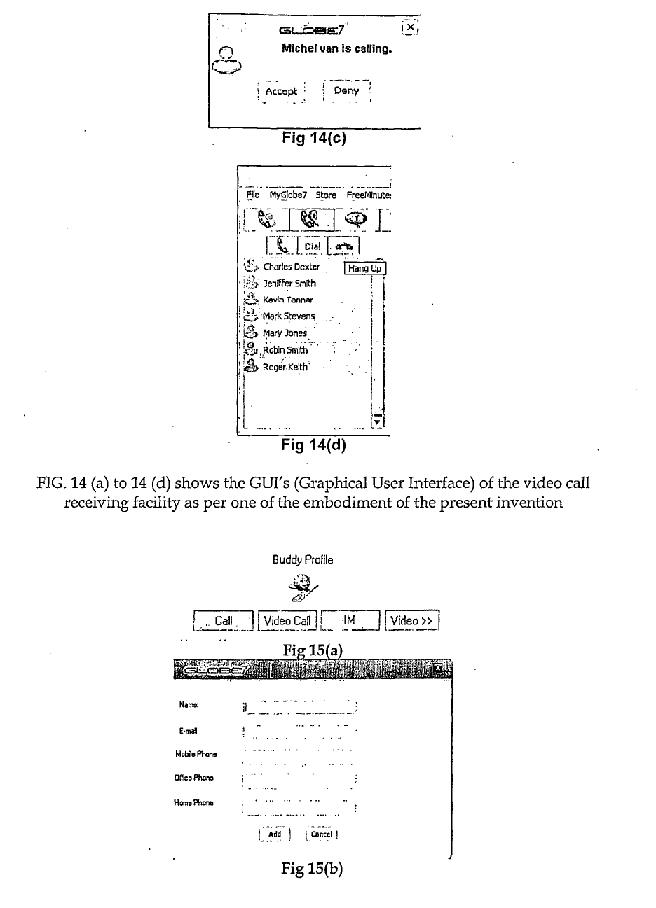

For answering a video call, when a person makes a video call a user, user hears a ringing sound. A call alerting box pops up allowing the user either to accept or deny the call. Clicking the ‘Accept’ button joins/connects the call. FIG. 14 (a). Also the user can answer a video call by clicking the ‘Answer’ button. FIG. 14 (b)

For disconnecting a Video Call, when a user receives a video call from a person, a call alerting box pops up allowing the user either to accept or deny the call. Clicking ‘Deny’ button disconnects the call. FIG. 14(c). Also the user can disconnect the call by clicking the ‘Hang Up’ button. FIG. 14 (d)

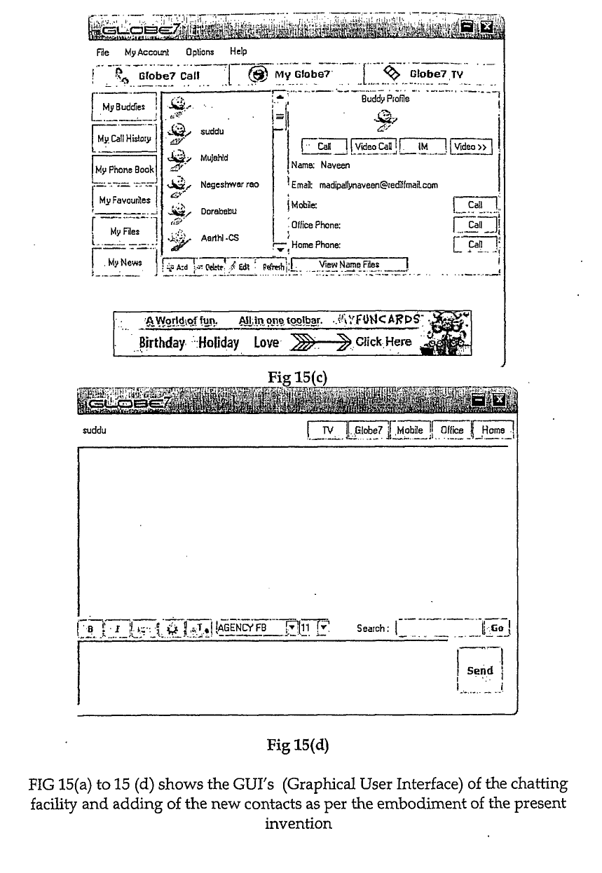

For adding a new contact with Globe7, the user can chat to any number of buddies simultaneously. Clicking the ‘Chat’ button opens the Chat screen. FIG. 15 (a). For starting a chaffing session, the user needs to add contacts to his Buddy List. For adding a new contact, click ‘Add a Contact’ button. FIG. 15 (b).

For adding the contact details a window opens wherein the user need to fill out the contact details. Name and Globe7 phone number fields must be filled. Clicking the ‘Save’ button stores the contact details. FIG. 15 (c). The user can add as many buddies as he likes. Once the user adds buddies to his Buddy List, he can send instant messages to them. FIG. 15 (d)

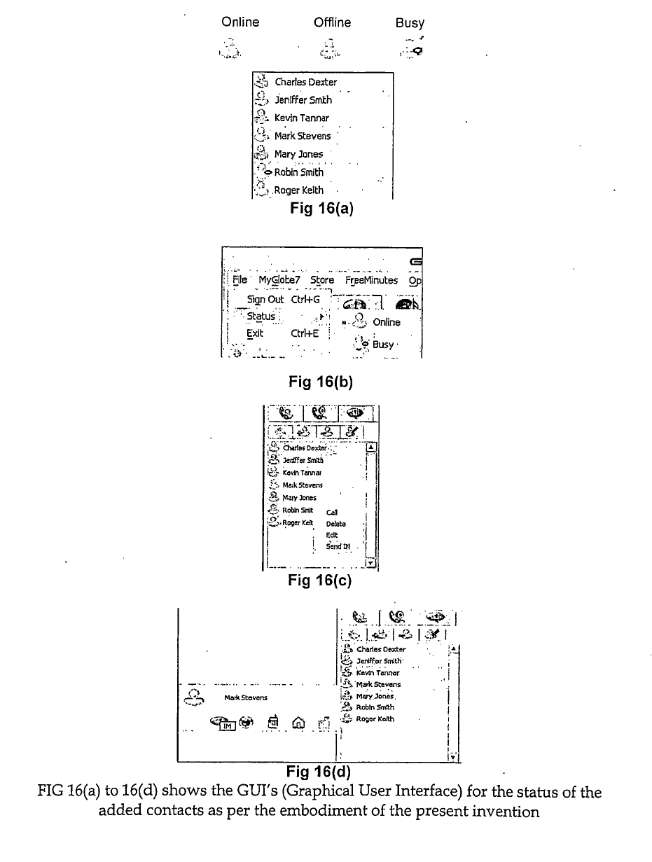

The user can see the live status of his buddies—whether they are online, offline or busy. FIG. 16 (a). For changing ones online status, he can go to the ‘File’ menu and select ‘Status’. If he intends to appear busy, he may select the ‘Busy’ mode and his buddies will find his status as busy. FIG. 16 (b)

As per one of the exemplary embodiment of the present invention the user can send and instant message (IM) to his buddy in four different ways.

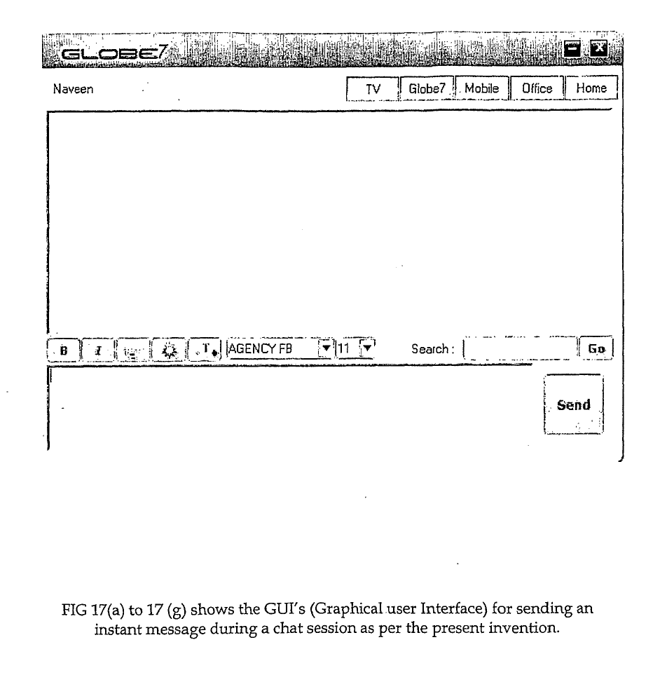

a. By selecting and right-clicking the contact. Click ‘Send IM’ to open a chat window. FIG. 17(a)

b. By selecting a contact. A profile window opens with the display of a chat icon along with the phone icons. By clicking the chat icon to open the chat window. FIG. 17 (b)

c. By Double-clicking the contact in the Buddy List.

d. By selecting the contact and press ‘Enter’.

After the aforesaid act a chat window opens and the user has to just type the message in the Input text area and then click ‘Send’. FIG. 17(c). When the buddy (users contact person) responds to him, he can see the message in the message display area. With Globe7, he can chat to any number of your buddies simultaneously in separate chat windows. FIG. 17(d)

If the user receives a message from a new contact, he can add him to his Buddy List directly from the chat window automatically. Further the user can cut, copy and paste the text messages for further usage. To use copy, cut and paste options, he has to go to ‘Edit’ menu and select his option. FIG. 17 (e)

He can alert his buddy by sending him a ‘Bingo’. He can also send emotions to his buddy through the chat window by choosing an emotion icon to send his buddy. He can also change the font and font size or send the text in bold and italics. FIG. 17(f). Moreover, he can also search the Web through the chat window by entering a keyword to search the Web and click ‘Go’. His search results will be displayed in a browser. FIG. 17 (g)

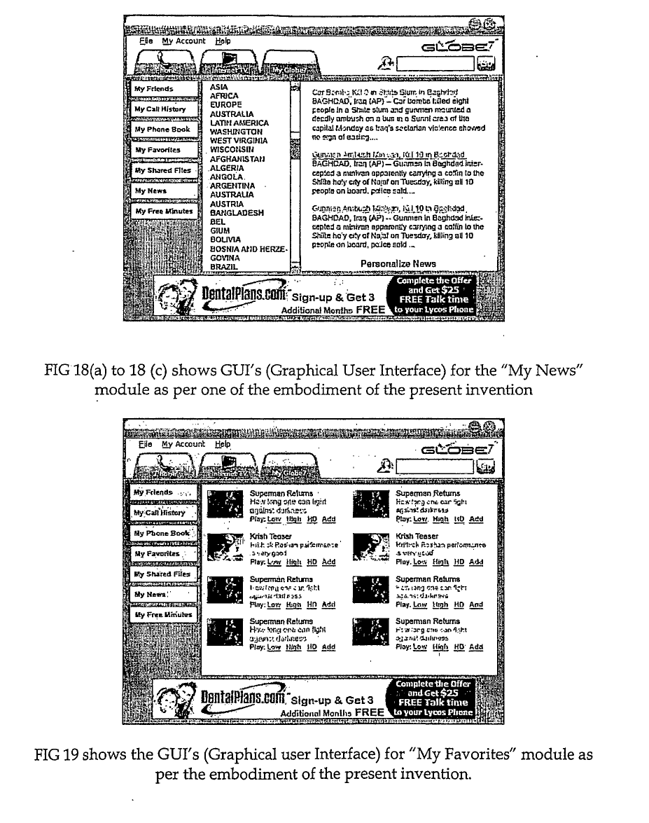

As shown in FIG. 18, the RSS is basically used for sharing headlines and other Web content. In the particular Module the user is allowed to select his domain of interest and the updated news related to his domain is being displayed and the contents are found scrolling upward. The user can also click on any module and the sub-modules of it will be appearing as a menu, when the menu is clicked that particular news will be scrolling up. When the user clicks a particular Module, a http Request will be sent to server which will respond to the request. As the result the news will be displayed. As shown in the diagram the user has selected the sports module and the sub-modules like football news, cricket, and hockey are displayed to the left and on clicking those sub modules the news is displayed on the right scrolling upward.

The objective of the favorites module (FIG. 19) is to add the favorite videos which the user desire to his application. The user can select his video of interest from globe 7 TV and can add it to “My favorites module”. The user can view the same videos once again when ever he desire.

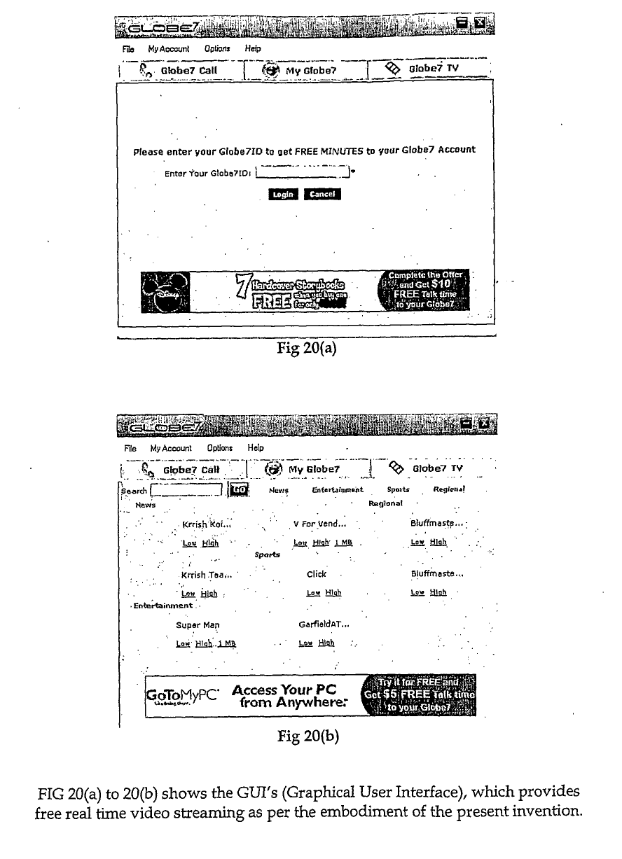

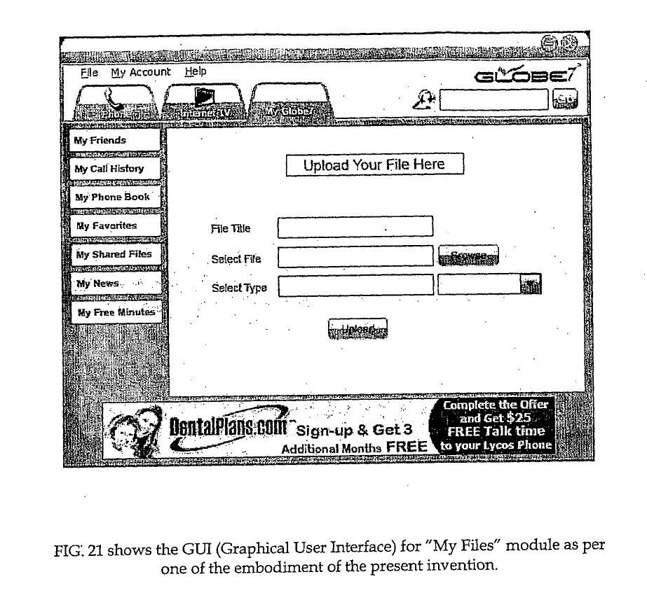

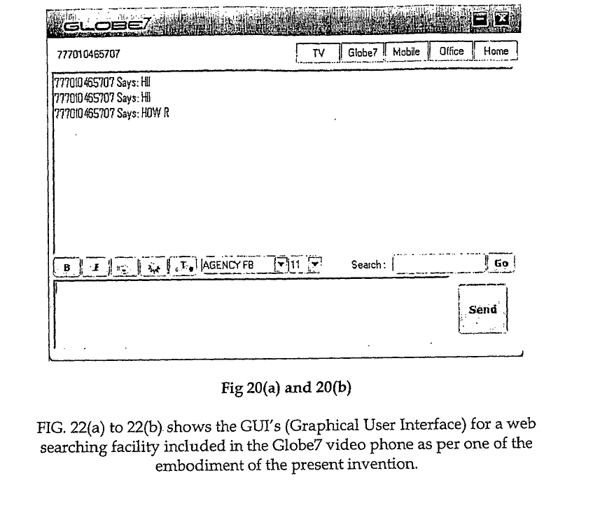

Under the TV section the Globe7 provides free online video streaming. The user can watch numerous TV channels, movie trailers, business news, sports and more by clicking the TV tab to enter the video services zone. FIG. 20(a). The Globe7 Online tree can be expanded. The user can find various categories such as movie trailers, live TV channels, etc. He can play, pause or stop the video using the tool box below the video screen. FIG. 20(b). Further the user can:—

a. Look for a station and double click.

b. The content should start loading and the progress is displayed at the left bottom. Channel.

c. Select a channel and then click the play button. As more and more channels add to the list, you can refresh the channels list now and then. To refresh the channels list, Click ‘Refresh List’.

As per the exemplary embodiment stated above there

a) To watch the channel in full screen, double click on the media window. Press escape key or double click on the screen to restore the media.

b). To watch another channel, double click on the channel to play.

c). To play another channel, stop the current is provided a “My files module” (FIG. 21) is basically used to upload audio, video and image content for any user. The user can upload up to 10 GB of content. The buddies who add the user will be able to see all the content by clicking on “view name files” button present in buddies module. With this module the user can share his image data, audio files and video files to his Globe7. The user will also be able to preview the data which he has uploaded.

As per another exemplary embodiment of the present invention there is provided a soft video phone integrated with online advertisements and online trading facilities to help the user to buy, sell or advertise their products to millions of users. The module is named as “store module”. Under this provision the user can add funds to his account to buy, sell or advertise the products over the soft phone. All the funds are transferred over a secured and dedicated server under the guidance and the rules framed by the service provider. The user can also earn free talk time by in the following ways.

1. By watching the interactive internet television.

2. By you can earn free minutes by referring to a friend (or) by filling the offers.

In order to recharge the account, the user can go to the stores module and select the desired recharge option. The user can find the necessary help and the web interface guides him about the process for recharging.

As per another exemplary embodiment of the present invention, there is provided a online tracking tool which tracks the user's geographical and demographic regional of location, usage of Globe 7 application features such as video viewing, viewing category, duration, online shopping behavior and the like.

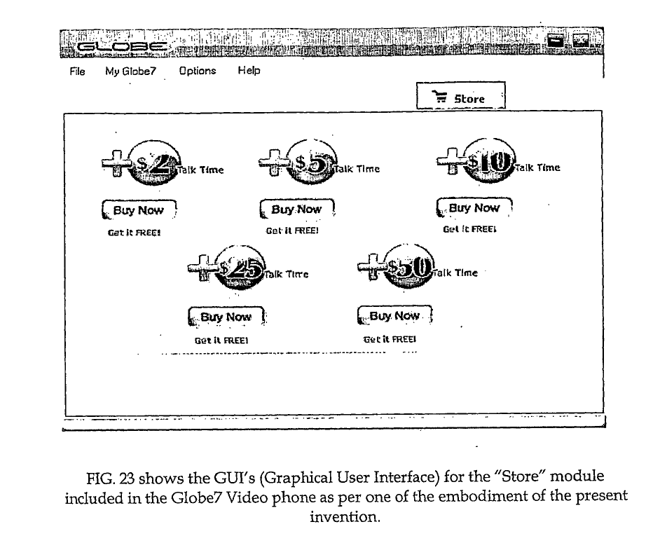

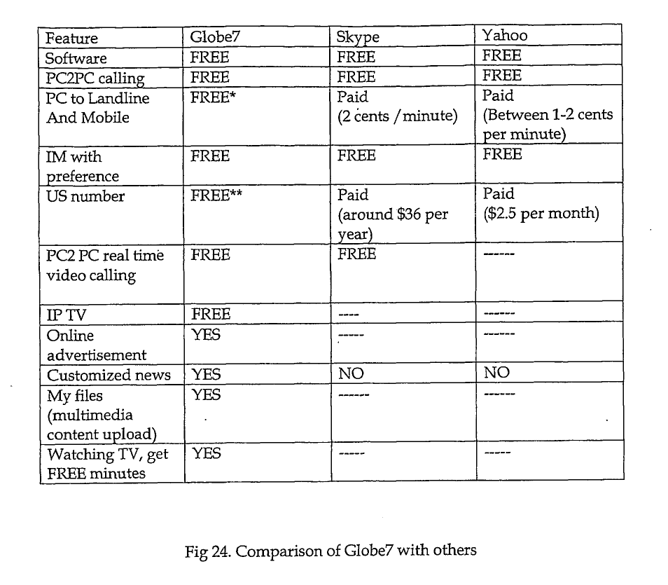

As per one of the exemplary embodiment of the present invention a user can search the Web. The user can search the Web even while he is using Globe7 for making calls or listening to music or watching the tv channels. The search box is ever visible on the top right of the Globe7-application. Enter a keyword to search the Web and click ‘Go’. The search results open in a browser. FIG. 22 (a). Furthermore the user can also search the Web through the chat window even while you chat with your buddy. Enter a keyword to search the Web and click ‘Go’. FIG. 22 (b)

The above-described embodiments of the invention are intended to be examples of the present invention. Numerous modifications changes and improvements within the scope of the invention will occur to the reader. Those of skill in the art may effect alterations and modifications thereto, without departing from the scope of the invention, which is defined solely by the claims appended hereto.

I claim:

1. A method for controlling advanced multimedia features and supplementary services in SIP based phones, the method comprising the steps of:
generating a caller application which initiates and sends SIP requests through at least one user agent client (UAC);
receiving and responding to the SIP requests on the behalf of the clients through at least one user agent server (UAS);
contacting one or more clients or the next server and passing the call requests further through at least one proxy server;
accepting the SIP requests and mapping the addresses into zero or more new addresses and return those addresses to the clients by at least one redirect server;
identifying a profile from user account information, stored on at least one server, the said profile specifying which features and services may or may not be implemented by an end device;
adding the profile to at least one message; and
sending the at least one message from the network core device to the end device.

2. The method for controlling multimedia features and supplementary services as claimed in claim 1, further comprises a voice over internet protocol (VOIP) having a session initiation protocol (SIP) with SIP User Agent [RFC-3261] with multi-featured phone designed for enterprises and residential use.

3. The method as claimed in claim 1, wherein the coding and the flow is created in CNC++ for increasing speed further reducing the memory size to only 5 MB and the SIP stack being used is OSIP RTP with handling based on ORTP.

4. The method as claimed in claim 2, wherein the SIP video phone further comprises of IM, video phone, and real time video streaming powered by online advertising including interactive video advertisements, banner advertisements and text advertisements.

5. The method as claimed in claim 4, wherein the said SIP Video Phone converts a laptop or desktop into a second telephone, from which user can make calls to any phone around the world and also receive incoming calls from any landline or mobile phone across the world with the Video Phone.

6. The method as claimed in claim 5, wherein the said SIP Video Phone provides means for PC to PC real time video calls, PC to land phones, PC to mobiles and vice versa with the help of some attachments like a webcam, a microphone and headset.

7. The method as claimed in claim 5, wherein the said SIP Video Phone provides means for chatting where the multiple users are added to a contact list and then chatting could be initiated.

8. The method as claimed in claim 2, wherein the said SIP Video Phone further comprises an interactive solution characterized by offering free talk time to the users based on the duration of viewing the internet television, using and interacting with the disclosed soft phone and also incorporating some viewer friendly solutions for entertainment, communication across the globe.

9. The method as claimed in claim 2, wherein the said SIP Video Phone provides an incessant entertainment with online video streaming.

10. The method as claimed in claim 8, wherein the said SIP Video Phone is integrated with “my news module” thereby facilitating the user by watching the news and customize the news according to his interest

11. The method as claimed in claim 2, wherein the said SIP Video Phone includes a phone number, which is also a worldwide number.

12. The method as claimed in claim 4, wherein the advertisements, trading, searching of web are interconnected and are tracked by geographic and demographic based locations on user's interests.

13. The method as claimed in claim 4, wherein the method is embedded with an online tracking tool which tracks user's behaviour.

14. The method as claimed in claim 2, wherein the said SIP Video Phone provides a ‘Follow Me Service’ facilitating the user in getting their calls redirected to their landline or mobile phone when they are offline.

15. The method as claimed in claim 2, wherein the said SIP Video Phone provides a mechanism by which the user can search/surf the Web even while making calls or chatting.

16. The method as claimed in claim 2, wherein the said SIP Video Phone provides a soft video phone integrated with Internet TV with its own channel called Globe-7 TV along with other numerous TV channels.

17. The method as claimed in claim 2, wherein the said SIP Video Phone provides a soft video phone integrated with “My Files” module, facilitating the user to upload audio files, image files and video files of his area of interest, up to the size of 10 GB.

18. The method as claimed in claim 2, wherein the said SIP Video Phone provides a soft video phone integrated with the IM environment possessing number of unique and interesting emotion icons expressing the feelings non-verbally and symbolically.

19. The method as claimed in claim 5, wherein the said phone facilitating voice call, further comprises the features of:
Call forwarding, Call blocking or Ignoring calls, Call return, Call trace, Last Call Duration, Recent Number List, Caller ID, Compatibility with Windows 2000/XP operating systems, Proxy Authorization support, Address Book, Volume Visualization, Easy User Installation, Click to call, Music player, Business Processing, Realtime online adding of funds, Caller ID blocking, Priority ringing and Conference calling.

20. A method as claimed in claim 1, further comprising the step of implementing on the end device (UAC) only the features and services allowed to be implemented by the profile of the at least one message.

21. The method as claimed in claim 1, further comprising the step of using a session initiation protocol phone for the end device (UAC) and a session initiation protocol server for the (UAS).

22. The method as claimed in claim 2, wherein the said SIP Video Phone provides a soft video phone integrated with Phone Book enabling the user to add some of information like name, e-mail, Office phone, Mobile and home phone etc which helps/assists the user in making a call via disclosed phone to others number.

23. The method as claimed in claim 2, wherein the said SIP Video Phone provides a soft video phone integrated with “View name files” enabling the user to share other buddy files.

24. The method as claimed in claim 2, wherein the said SIP Video Phone provides a soft video phone integrated with “My favourites module” which includes videos of the area of interest of the user.

25. The method as claimed in claim 2, wherein the said SIP Video Phone provides a soft video phone integrated with Auto login and Auto Startup facility incorporated for regular users which facilitates the regular users to login without typing the user name and password every time in his system.

26. The method as claimed in claim 2, wherein the said SIP Video Phone provides a soft video phone integrated with online advertisements and online trading facilities to help the user to buy sell or advertise their products to other users.

27. The system for controlling advanced multimedia features and supplementary services in sip-based phones wherein the user agent server (UAS) which receives and responds to the Sip requests on behalf of the clients and accepts, redirects or refuses calls, the server comprising:
a Reliable Data Transfer (RDT) message processor capable to extract information on requested data from a received RDT message, and transform the information on requested data into an RDT message; and
a data controller, operable to send an RDT message received from the SIP stack to the RDT message processor and transfer information for the extracted data to the RDT message processor, and send information on data received from the data provider to the data provider and transfer a transformed RDT message to the SIP stack; and
a data provider operable to provide data corresponding to the information on requested data to a data controller; and
a Session Initiation Protocol (SIP) stack operable to communicate an SIP message including an RDT message between the clients.

28. The system as claimed in claim 26, wherein the system further comprises of a user agent client (UAC), which requests a server for data, the client comprising:
A Reliable Data Transfer (RDT) message processor capable to convert information on requested data into an RDT message and extract the requested data from a received RDT message;
a data controller, operable to send information on requested data to the RDT message processor and transfer a transformed RDT message to the SIP stack, and send an RDT;
message received from the SIP stack to the RDT message processor and transfer information on the extracted data to the data application unit.
a data application unit operable to process or store the extracted data;
a Session Initiation Protocol (SIP) stack operable to communicate an SIP message including an RDT message between the server.

29. A system for controlling multimedia features and supplementary services in SIP based phones as claimed in claim 26, the system incorporating the method as claimed in any of the preceding claims.
